(19) United States
(12) Patent Application Publication
(10) Pub. No.: US 2004/0113751 A1
(43) Pub. Date: Jun. 17, 2004

(54) Method for producing thin film sensors, especially hot film anemometters and humidity sensors

(76) Inventor: Wolfgang Timelthaler, Engerwitzdorf (AT)

Correspondence Address: John C Freeman, Brinks Hofer Gilson & Lione, NBC Tower Suite 3600, PO Box 10395, Chicago, IL, 60610, US

(21) Appl. No.: 10/451,583

(22) PCT Filed: Dec. 5, 2001
(86) PCT No.: PCT/EP01/14229

(30) Foreign Application Priority Data
Dec. 21, 2000 (DE) 100 63 794.9

(51) Int. Cl. H01C 1/012

(52) U.S. Cl. 338/309; 338/35; 338/25

(57) ABSTRACT

A method for producing thin film sensors that includes applying a sensor structure to a front of a glass substrate so as to define a combination, connecting a support on a front of the combination. The method further includes removing a portion of the glass substrate over a large surface from a direction directed from a back of the combination down to a final thickness (d) of the glass substrate and releasing a connection between the support and the combination.

The invention relates to a method for producing thin film sensors, having a glass substrate. The invention also relates to hot film anemometers and humidity sensors produced in accordance with this method.

Thin film sensors are employed in large numbers in the automobile industry for measuring the intake air mass flow of internal combustion engines, or as humidity sensors.

Because of high demands made in regard to chemical resistance and in connection with temperature stresses, hot film anemometers for determining gas mass flows are often produced on a substrate of glass. These layers of approximately 1 μm thickness, often made of molybdenum or platinum, are applied to this glass substrate, for example by evaporation sputtering or cathode sputtering (sputtering). In many cases, this combination is afterwards provided with a protective layer and a contact layer. The required sensor structures are then worked out of the applied layers, for example by means of a selective photo-etching process.

Capacitive humidity sensors are produced in the same way as thin film sensors. For this purpose, electrodes which for example mesh with each other in a comb-like manner are applied to the glass substrate. A humidity-sensitive layer is applied on top of this, which most frequently consists of a polymer material. The capacitance of the electrode arrangement changes because of the water absorption, which is a function of the relative humidity, by the humidity-sensitive layer. It is then possible to determine the relative humidity by measuring the capacitance. The least possible thickness of the substrate should be attempted for further miniaturization and for reducing the thermal reaction time of these sensors.

In particular in connection with hot film anemometers it is important that a rapid reaction speed be assured, or that these sensors have a low thermal time constant. For this reason hot film anemometers are produced with as thin as possible a substrate. Usually two measuring resistors, one of which is designed as a heater resistor, are located on this glass substrate. During an operation at excess temperature, the temperature, or the resistance, of the downstream located heating resistor is maintained constant, which is achieved by tracking the sensor current. The sensor current is simultaneously used as the measurable variable for the flow-through rate of the intake air. Pulsations in the intake part of the engine and possible flow reversal, in combination with a report regarding a non-linear characteristic of a hot film anemometer, lead to erroneous measurements, which can no longer be accepted in modern engine management systems. It is therefore the aim to realize a hot film anemometer having a lesser thermal time constant. The heat capacity of the substrate is reduced by substrates of little thickness, by means of which the interfering heat flow between the substrate and the sensor structures, which falsifies the measured result, is minimized in the thermally non-stationary operation.

To achieve sufficiently low time constants, substrate thicknesses of maximally 150 μm are required. It is intended to preferably obtain substrate thicknesses of 100 μm and down to approximately 50 μm or less. The production of thin film sensors in large numbers on substrates of such thinness, in particular glass substrates, is especially difficult for reasons of production technology, and is accompanied by large reject rates.

In the course of producing thin film sensors, commercially available glass pieces of a thickness between 100 μm and 150 μm usually are employed as substrates. The sensor structures of several sensors are applied to these glass substrates. Thereafter, protective and contact layers are also applied as a rule. Considerable tensions are generated in the thin glass substrate by the coating. Because of breaks and cracks, these tensions lead to reject rates, which are not negligible, already in the production of undivided glass substrates. However, in this connection the cutting of the finished glass substrates to the final dimensions of the sensors is particularly critical. During this work step, additional tensions are unavoidably introduced into the glass material, which then quite often leads to breaking of the glass material. To keep the reject rate within limits, it has only been possible up to now to use glass substrates of a maximum size of 2 inches×2 inches. Moreover, the above described tensions, if they do not lead to breaking, generate warping of the glass material. These non-systematic deformations are the limiting factor for attempts to automate the production of thin film sensors on glass substrates.

A method is known from WO 98/34084, wherein an additional membrane layer is applied to a glass support. From the direction of the back, the glass support is then removed on a relatively small partial surface up to the membrane by a selective etching process. The membrane, which can consist of several layers, is then used as a substrate, so to speak, for the sensor structures of the hot film manometer. It is possible in this way to produce thin film sensors of little substrate thickness. These extremely low substrate thicknesses do have the advantage that the reaction time of the hot film manometers is reduced, but they are extremely sensitive with respect to mechanical stresses. This type of construction has been shown to be too delicate, especially for an application in motor vehicles.

A method for producing humidity sensors on a glass substrate by means of thin film technology is described in EP 0 043 001 B1. In this case the initial thickness of the glass substrate is not further reduced after the application of the sensor structures. The active removal of glass material from the substrate during the etching process is even actually prevented. Therefore the production of thin film sensors with thin glass substrates is extremely tricky and uneconomical with this method.

The object of the invention is therefore based on producing a method which allows an efficient production of thin film sensors on thin glass substrates in large numbers.

This object is attained by means of the method in accordance with claim 1.

Advantageous embodiments of the method of the invention ensue from the steps in claims depending from claim 1.

On the basis of the steps in accordance with the invention, commercially available glass plates of an initial thickness D of 0.3 mm to 0.9 mm can be used as the starting material for the glass substrate. In contrast to the initial glass substrate formats of 2 inches by 2 inches, possible up to now, it is possible by means of the novel method to employ respective plates in a square shape with lateral lengths of 4 inches, or round plates of 6 inch diameter. Accordingly, when employing these plate sizes, the surface which can be used for the application of sensor structures having an edge length of only a few millimeters is increased by a factor between 4 and 7. In the same way, by means of the novel method it is possible to apply and configure 4 to 7 times as many sensor structures at an acceptable reject rate. At the same time, a clearly reduced danger of breakage results from this method.

Further advantages, as well as details of the method in accordance with the invention ensue from the subsequent description of a possible exemplary embodiment by means of the attached drawings.

Shown are in:

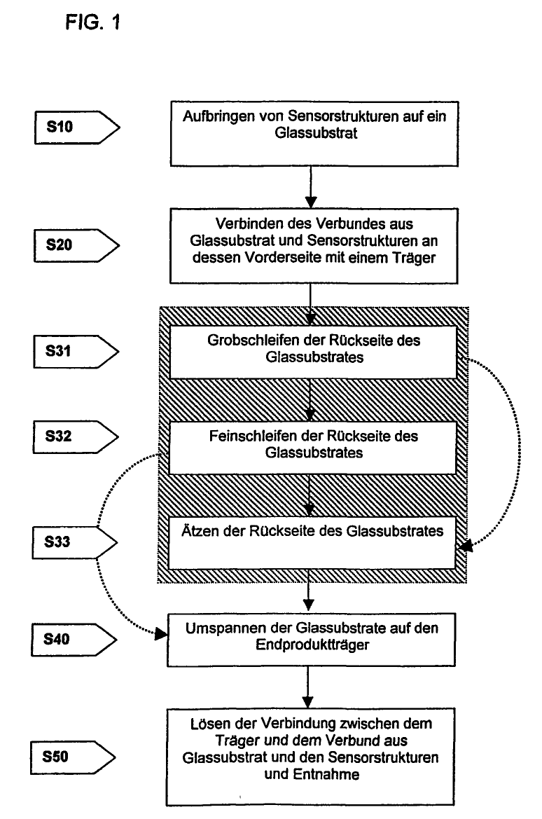

FIG. 1, schematically the respective method steps for producing thin film sensors,

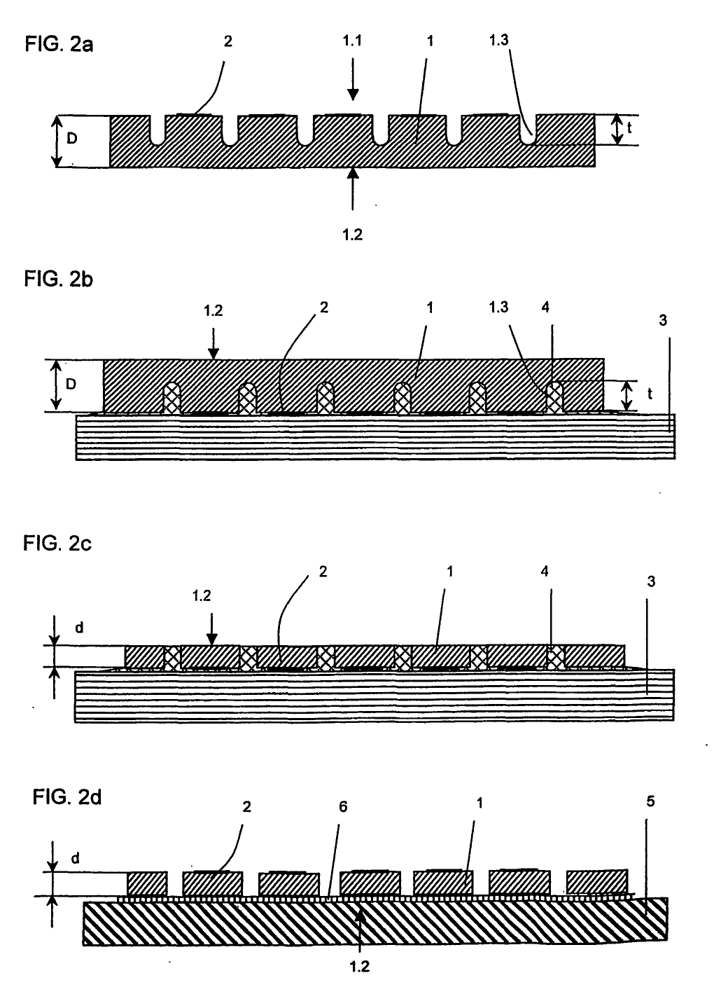

FIG. 2a, a cross section through a combination of glass substrate and sensor structures after scribing the troughs,

FIG. 2b, a cross section through a combination of glass substrate and sensor structures in connection with the support,

FIG. 2c, a cross section through a combination of glass substrate and sensor structures in connection with the support after grinding,

FIG. 2d, a cross section through the remounted finished thin film sensors.

FIG. 1 is essentially intended to explain the sequence of the method. The production process is shown by means of cross sections in FIGS. 2a to 2d. In FIGS. 2a to 2d identical parts are identified by the same reference symbols.

In the example represented, sensor structures 2 are first applied in work step S10 on a square glass substrate 1, having an initial thickness D of 0.5 mm and an edge length of 4 inches. In this case the sensor structures 2 are intended for a hot film anemometer and therefore consist of a measuring resistor and a heating resistor and the associated protective and contact layers.

Alternatively to this, the sensor structures 2 can also be comb-shaped electrodes with an appropriate humidity-sensitive coating and, if required, additional protective coatings for humidity sensors.

By definition, the side of the glass substrate 1 to which the sensor structures are applied is identified as front 1.1. The opposite side of the glass substrate is accordingly called back 1.2. Because of the comparatively large initial hickness D, and the high mechanical stability of the glass substrate connected therewith, its handling is without problems. Even after the application of the sensor structures 2, the comparatively thick glass substrate practically never shows fractures or warping. For example, the sensor structures 2 for a hot film anemometer consist of molybdenum strip conductors, which are applied to the glass substrate 1 by sputtering. Thereafter, these strip conductors are coated with a protective layer, which in turn is provided with a contact layer of gold. The appropriate structures are subsequently brought out by means of a selective photo-etching process.

In the example represented, as soon as the production of the sensor structures 2, consisting of the above mentioned layers, is terminated, the glass substrate 1 is scribed in two directions, which extend vertically to each other (FIG. 2a). The depth t of the troughs 1.3 cut in this way is selected here in such a way that, following the grinding process of the back 1.2 of the glass substrate 1 described below, only the rectangular thin film sensors remain, without connecting bridges, in the glass substrate 1. In other words, the depth t of the troughs 1.3 is greater than the final thickness d of the glass substrate 1.

Then, in step S20, the front of the combination consisting of the glass substrate and the sensor structure is connected with a support 3. This takes place, for example, by means of a releasable adhesive mounting connection. In accordance with the example represented, a melt adhesive in the form of a wax 4 is considered, which is applied to the front 1.1 of the combination of the sensor structures 2 and the glass substrate 1 in liquid or viscous form. Then, in accordance with FIG. 2b, the front 1.1 is brought into contact with the support 3, which preferably is also made of glass. The wax 4 is subsequently permitted to cool, so that it solidifies and in this way forms an immovable connection between the support 3 and the combination of the sensor structures 2 and the glass substrate 1.

Besides waxes, it is also possible to use other melt adhesives, for example rosin, or synthetic compounds, for example from the category of polymer compounds. At a later time the connection can be released again by heating to a temperature above the melting point of the adhesive.

Adhesive foils, which have been coated with adhesive on both sides, can be employed in an alternative, releasable adhesive mounting connection. The use of these adhesive foils has the advantage that the sensor structures 2 dig into these foils by means of the pressure of the subsequent cutting processes, so that local pressure peaks in the sensors to be produced can be avoided. The term adhesive foils of course also means equivalently acting flat materials, such as adhesive textile strips or adhesive foam foils, etc. It is possible in connection with these adhesive foils to preferably employ foils with an adhesive coating, whose adhesiveness is significantly reduced, or vanishes, under the influence of UV light. In this way it is possible by suitable irradiation to deactivate the adhesive effects at the desired time.

In a further embodiment of the invention, the connection between the combination of a glass substrate 1 and the sensor structures 2 with the support 3 can also be provided by means of underpressure. In this case, air is aspirated through a perforated support 3, for example. As soon as the glass substrate 1 with the sensor structures 2 is connected with the support 3, the pressure on the suction side of the underpressure source drops, so that a contact pressure force is created as a result of the pressure difference between the surroundings and the contact surface. So that the sensor structures 2 are not damaged when mounted on the support 3, it is practical to provide a suitable intermediate layer of a soft material.

In accordance with the exemplary embodiment represented, the substrate material is subsequently removed from the direction of the back 1.2 in three partial steps (S31, S32, S33) down to the resultant final thickness d of the glass substrate 1 (FIG. 1).

First, in step S31, the entire back 1.2 of the mounted glass substrate 1 is worked with a relatively coarse grinding tool. It is the aim of step S31 to remove the by far greatest portion of the substrate material to be cut off already at this point, so that following S31 the initial thickness D is hardly greater than the resultant final thickness d of the glass substrate 1 to be achieved.

The invention is not limited to working the entire back 1.2 of the glass substrate 1, instead a removal of a large surface of the back 1.2 down to the resultant final thickness d of the glass substrate is meant in this connection. This means that, related to the surface, at least 75% of the back 1.1 of the initial glass substrate is subjected to the removal process. As methods for performing the removal of substrate material it is possible to employ polishing and etching processes, for example, and not only the grinding method.

The first removal step is often decisively used for the removal of a majority of the volume of substrate material, approximately 60% to 75% or more, to be removed. The removal process can already be terminated after this step, provided the final thickness d of the glass substrate has be reached and the worked surface has a sufficient quality with respect to roughness.

However, subsequently to the first rough removal step in the course of the removal process, the back 1.2 is advantageously subjected to a second step (S32) within the framework of further processing for reducing roughness. This is intended to remove tension peaks caused by micro-nicks in the surface. The glass substrates 1 processed in this way are then mechanically relatively insensitive, in spite of their reduced thickness. Therefore, in the present exemplary embodiment, the previously roughly ground back 1.2 is subjected to a fine grinding process in step S32 (FIG. 1).

Alternatively to fine grinding it would also be possible to perform a polishing process, for example. It is also possible to employ other suitable surface treatment methods for reducing the roughness of the back 1.2. These steps can be, for example, the above mentioned ones, wherein these can be performed individually, superimposed on each other, or in any arbitrarily combined sequence.

A further increase of the mechanical load capacity of the thin sensors is possible by means of a further removal step, in the present example an etching process S33 of the back 1.2 in accordance with FIG. 1. The surface of the back 1.2 becomes extremely smooth by etching it in this area, by means of which nick tension peaks are removed to the greatest extent. In this step, the back 1.2 of the glass substrate 1 is treated with hydrofluoric acid. Micro-bumps are removed from the back 1.2 until the final thickness d of the glass substrate 1 has been reached (FIG. 2c). The glass substrates 1 treated in this way then have a very smooth back 1.2. Dry-etching processes or polishing etching processes can be employed alternatively or additionally in the represented example.

Following the last removal step, the comparatively small thin film sensors are now individually located independently of each other on the support (FIG. 2c). To combine the thin film sensors in suitable numbers for further handling, in the example represented they are then remounted on a so-called end product support 5 (S40, FIG. 1). To this end, the backs of the thin film sensors are connected with the end product support 5 by means of a remounting adhesive. At this time, the fronts 1.1 of the thin film sensors are still connected with the support 3 because of the wax as the mounting adhesive. Similar to the mounting adhesive 4, the remounting adhesive 6 is also a removable adhesive. But in this case the remounting adhesive can be deactivated by means of UV light in contrast to the mounting adhesive 4—a wax in the present example—.

In principle it is useful to employ different types of adhesives for the mounting and the remounting adhesive 4, 6. It is particularly advantageous, if the mounting and remounting adhesives 4, 6 can be deactivated by means of different steps or functional principles (UV light, heat). In the same way it is possible to employ mounting and remounting adhesives, whose effects are reduced at different temperature levels. It is possible in this way to selectively release the respectively desired adhesive connection.

Finally, in step S50 the connection between the support 3 and the composition of the glass substrate 1 and the sensor structures 2 is released again. To this end the arrangement is heated, so that the wax 4 is subjected to a temperature above the melting point of the latter. In spite of this heating, the remounting adhesive 6 continues to remain active. Then the finished thin film sensors are only in contact with the final product support 5. If required, it is also possible to place soldering bumps for the connection technique for the thin film sensors. The finished thin film sensors are shipped together with the end product support 5.

The dashed arrows in FIG. 1 are intended to convey that in different embodiments of the invention respective work steps can also be omitted. The represented example is not intended to limit the invention to that example. For example, by means of the method in accordance with the invention it is also possible to perform only one removal step, which is either comprised of one of the processes S31, S32 or S33, or a different removal process.

1. A method for producing thin film sensors, wherein
sensor structures (2) are applied to the front (1.1) of a glass substrate (1),
the combination of the glass substrate (1) and the sensor structures (2) is connected on its front (1.1) with a support (3),
subsequently the substrate material is removed over a large surface from the direction of the back (1.2) down to a final thickness (d) of the glass substrate (1),
finally, the connection between the support (3) and the combination of the glass substrate (1) and the sensor structures (2) is released again.

2. The method in accordance with claim 1, wherein the removal of the substrate material comprises at least two removal steps, a first removal step being a grinding process, and at least one subsequent removal step including the reduction of the roughness of the back.

3. The method in accordance with claim 2, wherein a removal step following the first removal step includes a polishing process.

4. The method in accordance with claim 2, wherein a removal step following the first removal step includes a fine grinding process.

5. The method in accordance with claim 2, wherein a removal step following the first removal step includes an etching process.

6. The method in accordance with claim 1, wherein troughs (1.3) are cut into the glass substrate (1) from the direction of the front (1.1) prior to combining the support (3) with the combination of the glass substrate (1) and the sensor structures (2).

7. The method in accordance with claim 6, wherein the depth (t) of the troughs (1.3) is greater than the final thickness (d) of the glass substrate (1).

8. The method in accordance with claim 1, wherein the connection between the support (3) and the combination of the glass substrate (1) and the sensor structures (2) is provided by means of a releasable mounting adhesive connection (4).

9. The method in accordance with claim 8, wherein the connection between the support (3) and the combination of the glass substrate (1) and the sensor structures (2) is provided with the aid of a melt adhesive (4).

10. The method in accordance with claim 8, wherein the connection between the support (3) and the combination of the glass substrate (1) and the sensor structures (2) is provided with the aid of an adhesive foil.

11. The method in accordance with claim 1, wherein the connection between the support (3) and the combination of the glass substrate (1) and the sensor structures (2) is provided with the aid of underpressure.

12. The method in accordance with claim 1 or 6, wherein following the large-scale removal of the glass substrate (1) the combination of the glass substrate (1) and the sensor structures (2) is remounted on its back (1.2) on an end product support (5) and is connected therewith by means of a releasable remounting adhesive connection (6).

13. The method in accordance with claim 1 or 6, wherein following the large-scale removal of the glass substrate (1) the combination of the glass substrate (1) and the sensor structures (2) is remounted on its back (1.2) on an end product support (5) and is connected therewith by means of a releasable remounting adhesive connection (6).

14. A hot film anemometer, produced in accordance with at least one of claims 1 to 11.

15. A humidity sensor, produced in accordance with at least one of claims 1 to 11.
